(19) United States
(12) Patent Application Publication
(10) Pub. No.: US 2015/0254775 A1
(43) Pub. Date: Sep. 10, 2015

(54) LOCALLY OPTIMUM TRADING POSITIONS FOR PATH-DEPENDENT OPTIONS

(71) Applicant: TATA CONSULTANCY SERVICES LIMITED, Mumbai (IN)

(72) Inventors: Easwara Naga SUBRAMANIAN, Hyderabad (IN); Arihant JAIN, Hyderabad (IN)

(73) Assignee: TATA CONSULTANCY SERVICES LIMITED, Mumbai (IN)

(21) Appl. No.: 14/196,372

(22) Filed: Mar. 4, 2014

(51) Int. Cl. G06Q 40/06

(52) U.S. Cl. CPC G06Q 40/06

(57) ABSTRACT

A trading position evaluation system for evaluating trading positions that are locally optimum for a path-dependent European Contingent Claims (ECC) includes an option price determination module to determine a scaled option price and a shifted scaled option price of the path-dependent ECC based on ECC data and market data, retrieved from a database. The scaled option price and the shifted scaled option price are determined at a trading time instance, selected from amongst a plurality of trading time instances obtained from a trader, based on at least one discrete-monitoring time instance occurring before the trading time instance. Based on the scaled option price and the shifted scaled option price, a position evaluation module evaluates a trading position in an underlying asset of the path-dependent ECC at the trading time instance that minimizes local variance of profit and loss to the trader.

### TECHNICAL FIELD

The present subject matter relates, in general, to a path-dependent European Contingent Claim and, in particular, to a system and a computer-implemented method for evaluating locally optimum trading positions for the path-dependent European Contingent Claim.

### BACKGROUND

In today's competitive business environment, investment banks make profit by trading financial instruments, such as derivatives. A derivative is a contract between two parties, namely, a buyer and a seller. The seller of the contract is obligated to deliver to the buyer, a payoff that is contingent upon the performance of an underlying asset. In one example, a derivative may be an option written on the underlying asset. The underlying asset may be a stock, a currency, or a commodity. In some derivatives, payoffs have to be delivered at a fixed time to maturity. Such derivatives are in general known as European Contingent Claims (ECC). The ECC may be a European call or put option. Further, the ECC may be a path-dependent option, which means its payoff, in principle, could depend on historical prices of the underlying asset between time of initiation and time to maturity of the ECC. In practice though, the payoff depends on certain discrete time instances, between the time of initiation and the time to maturity of the ECC. In an example, a Cliquet option is a path-dependent option consisting of a plurality of forward start plain vanilla options expiring at different time to maturities. Path-dependent European Contingent Claims (ECCs) in general include path-independent ECCs whose payoff depend on the price of the underlying asset just at the time to maturity.

Selling or buying an option always implies some exposure to financial risk. In case of the European call option, the holder of an option pays a premium to buy the underlying asset at a strike price at the time of maturity of the option. The strike price is the contracted price at which the underlying asset can be purchased or sold at the time of maturity of the option. If the market price of the underlying asset exceeds the strike price, it is profitable for the holder of the option to buy the underlying asset from the option seller, and then sell the underlying asset at the market price to make a profit. Since the European call option provides to its buyer, the right, but not the obligation to buy, the buyer may thus have a chance to make a potentially infinite profit at the cost of losing the amount which he has paid for the option, i.e., the premium. The seller, on the other hand, has an obligation to sell the underlying asset to the holder at the strike price, which may be less than the market price of the underlying asset on the date of maturity of the option. Therefore, for an option seller the amount at risk is potentially infinite due to the uncertain nature of the price of the underlying asset. Thus, option sellers typically use various hedging strategies to minimize such risks.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1 illustrates a network environment implementing a trading position evaluation system, according to an embodiment of the present subject matter.

FIG. 2 illustrates a method for evaluating trading positions for a path-dependent European Contingent Claim (ECC), according to an embodiment of the present subject matter.

### DETAILED DESCRIPTION

The trading of financial instruments, such as a path-dependent ECC and other derivatives over computer networks, such as the Internet has become a common activity. Generally, any form of market trading involves a risk and so does the ECC trading. The risk to an ECC buyer is limited to the premium he has paid to an ECC seller. However, the risk to the ECC seller is potentially unlimited, while the profit earned by the ECC seller from the ECC sale alone is limited to the premiums earned. Accordingly, the ECC seller may hedge his risk by trading in the underlying asset of the ECC. The trading decisions taken by the ECC seller constitute the seller's hedging strategy. The net profit/loss incurred by the ECC seller at the time of maturity from selling the ECC and the hedging process is called as the hedging error. The hedging error represents the ECC seller's risk that the ECC seller may incur even after hedging. A judicious choice of a hedging strategy by the ECC seller may lead to a lower residual risk.

Conventional hedging techniques are often postulated on unrealistic assumptions that trades can be made continuously in time. Examples of such hedging techniques include Delta-hedging technique and Black-Scholes hedging techniques. When such techniques are used in realistic settings involving multiple discrete trading time instances, they fail to provide trading positions that are locally optimum in market probability measure, i.e., the trading positions that provides minimum local variance of profit and loss to a trader, for example the ECC seller at the time of maturity in this case. The term local variance may be understood as the variance of the profit and loss to the trader between successive trading time instances. Further, some existing techniques involve large number of parameters and complex calculations, thereby consuming lot of time and effort and are prone to errors.

The calculation of variance requires a choice of probability measure. The probability measure provides the probability of occurrence of different financial events, and represents the quantification of a subjective view of the relative likelihoods of various future events/scenarios. Each market player may use a different probability measure reflecting his or her own subjective views. The collective subjective perception of all the market players is captured by the market probability measure (hereinafter referred to as market measure). Market measures assigns probabilities to financial market spaces based on actual market movements. Though a risk-neutral probability measure is generally used for the purpose of pricing the options, the market measure is the real measure in which the market evolves. Hence, the sellers/traders struggle to minimize the risk in real world, i.e., the market measure.

The present subject matter describes a system and a computer-implemented method for evaluating trading positions for a path-dependent European Contingent Claim (ECC). The trading positions evaluated by the present system and method minimize the local variance of the profit and loss to a trader in the market measure. The system as described herein is a trading position evaluation system. In one implementation, trading positions in underlying asset are evaluated at a plurality of discrete time instances starting from the time of initiation till the time of maturity of the ECC. Such trading positions provide minimum local variance of profit/loss to a trader, say, an ECC seller. The term local variance may be understood as the variance of profit and loss to the trader between successive trading time instances.

Initially, a database for storing data associated with the path-dependent ECC is maintained according to one implementation. The database can be an external repository associated with the trading position evaluation system, or an internal repository within the trading position evaluation system. In the description hereinafter, a path-dependent ECC is referred to as ECC, and the data associated with the path-dependent ECC is referred to as ECC data. The ECC data may include the ECC defined by its payoff, time of initiation, time to maturity, a plurality of discrete-monitoring time instances that lie between the time of initiation and time to maturity of the ECC, premium, price of the underlying asset of the ECC at the time of initiation known as spot price, strike price of the ECC, and current market prices of plain vanilla call and put options written on the underlying asset of the ECC with the same time to maturity. In one example, the ECC data stored in the database may be obtained from the users, such as traders.

In the above mentioned implementation, the database is further populated with historical data including historical market prices of the underlying asset of the ECC. The historical market prices for the underlying asset can be automatically obtained from a data source, such as National Stock Exchange (NSE) website at regular time intervals, for example, at the end of the day and stored into the database. The data stored in the database may be retrieved whenever the trading positions are to be evaluated. Further, the data contained within such database may be periodically updated, whenever required. For example, new data may be added into the database, existing data can be modified, or non-useful data may be deleted from the database.

In one implementation, rate of return and volatility of the underlying asset of the ECC is computed based on the historical data associated with the underlying asset. To compute the rate of return and the volatility, historical market prices of the underlying asset for a predefined period, say, past two years, are retrieved from the database and log-returns are computed for the underlying asset based on the retrieved historical market prices. Thereafter, log-returns are fitted to a best-fit distribution to generate a plurality of scenarios. The best-fit distribution may be a Normal distribution, a Poisson distribution, a T-distribution, or any other known distribution that fits best to the log-returns. The scenarios, thus generated, may include already existing scenarios that have occurred in the past and other scenarios that have not existed in the past but may have a likelihood of occurring in the future. The scenarios, thus generated, are fitted to a normal distribution to compute the rate of return and the volatility of the underlying asset. The computed mean and volatility are thereafter annualized.

Further, a risk-free interest rate of the market is computed based upon the retrieved ECC data. The computed annualized rate of return and volatility, and the risk-free interest rate are stored in the database as market data. The database, thus, contains the ECC data, the historical data, and the market data. The data contained in the database can be retrieved by the trading position evaluation system for the purpose of evaluating trading positions. In one implementation, the market data, such as annualized rate of return, annualized volatility, and risk-free interest rate can also be computed in real-time during evaluation of the trading positions. The manner in which evaluation of trading positions takes place is described henceforth.

A trader may provide a plurality of trading time instances starting from the time of initiation till the time of maturity of the ECC as an input to the trading position evaluation system for trading of an underlying asset. Such trading time instances are the discrete time instances at which the trader may trade the underlying asset of the ECC.

Upon receiving trader's input, such as the trading time instances, the trading position evaluation system retrieves the ECC data and the market data associated with the underlying asset from the database. For each of the trading time instances specified by the trader, the trading position evaluation system then evaluates a locally optimum trading position in the market measure, i.e., the trading position provides minimum local variance of profit and loss to the trader.

To evaluate the trading position at a particular trading time instance, the trading position evaluation system determines a scaled option price and a shifted scaled option price of the ECC based on the retrieved ECC data and the market data. Such a determination of the scaled option price and the shifted scaled option price may take place using any known option pricing method and, in one implementation, may take place using a Black-Scholes pricing method or a Monte-Carlo pricing method. Subsequently, the trading position in the underlying asset is evaluated based on the determined scaled option price and the shifted scaled option price. The trading position conveys to the trader of the ECC, the number of units of the underlying asset to be held by the trader of the ECC at a particular trading time instance until the next trading time instance.

Thus, the trading position evaluated at each of the specified trading time instances starting from the time of initiation of the ECC till the time to maturity when taken together allows the trader to achieve minimum variance of profit and loss to the trader, such as an ECC seller, from the current trading time instance to the next trading time instance. As mentioned previously, such a variance of the profit and loss to the trader between successive trading time instances is known as the local variance. Thus, minimum local variance of profit and loss can be achieved by evaluating the trading positions at different trading time instances. Therefore, a risk incurred by the trader, especially the ECC seller, between successive trading instances is minimized. The ECC seller, for example, may be able to liquidate the underlying asset at the time of maturity in order to deliver the payoff to the ECC buyer at a minimum risk.

The system and the method described according to the present subject matter, evaluates the trading positions based on a simple analytical closed-form expression, which is provided in the later section. The trading positions evaluated by the system and the method efficiently minimize risk exposure to the traders. Based on the trading positions, a trader would know how many units of the underlying asset should be held at each trading time instance so that the risk exposure to the trader is minimized at the time of maturity of the ECC.

The following disclosure describes a system and a method of evaluating the trading positions for a path-dependent European Contingent Claim (ECC) that are locally optimum in the market measure. While aspects of the described system and method can be implemented in any number of different computing systems, environments, and/or configurations, embodiments for the information extraction system are described in the context of the following exemplary system(s) and method(s).

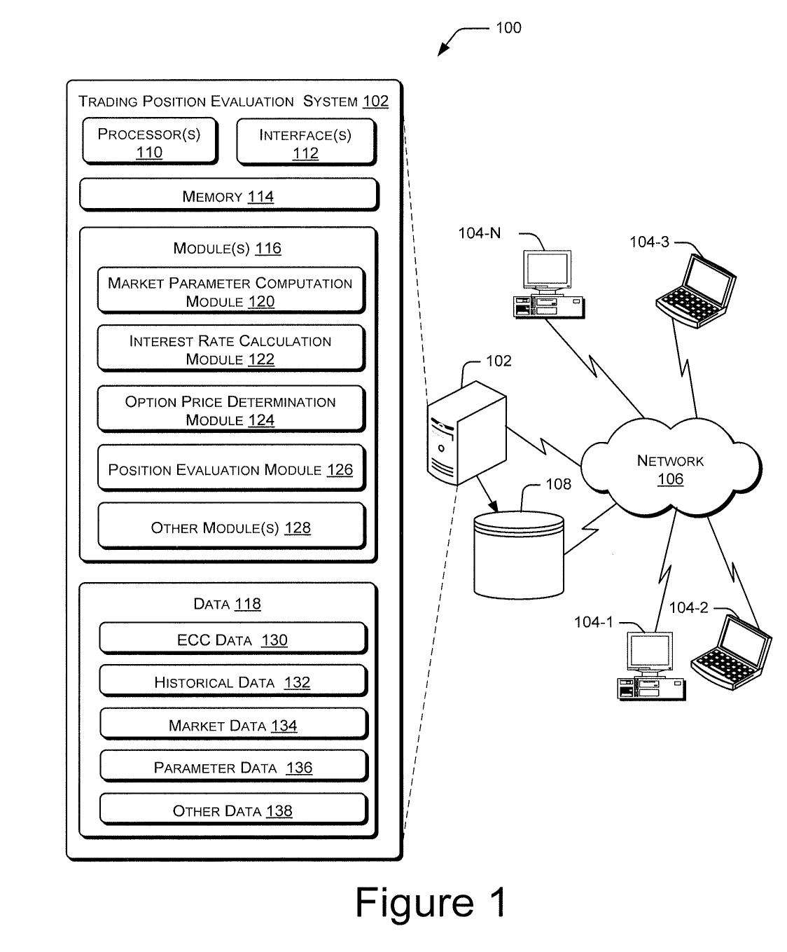

FIG. 1 illustrates a network environment 100 implementing a trading position evaluation system 102, in accordance with an embodiment of the present subject matter. In one implementation, the network environment 100 can be a public network environment, including thousands of personal computers, laptops, various servers, such as blade servers, and other computing devices. In another implementation, the network environment 100 can be a private network environment with a limited number of computing devices, such as personal computers, servers, laptops, and/or communication devices, such as mobile phones and smart phones.

The trading position evaluation system 102 is communicatively connected to a plurality of user devices 104-1, 104-2, 104-3 . . . 104-N, collectively referred to as user devices 104 and individually referred to as a user device 104, through a network 106. In one implementation, a plurality of users, such as traders may use the user devices 104 to communicate with the trading position evaluation system 102.

The trading position evaluation system 102 and the user devices 104 may be implemented in a variety of computing devices, including, servers, a desktop personal computer, a notebook or portable computer, a workstation, a mainframe computer, a laptop and/or communication device, such as mobile phones and smart phones. Further, in one implementation, the trading position evaluation system 102 may be a distributed or centralized network system in which different computing devices may host one or more of the hardware or software components of the trading position evaluation system 102.

The trading position evaluation system 102 may be connected to the user devices 104 over the network 106 through one or more communication links. The communication links between the trading position evaluation system 102 and the user devices 104 are enabled through a desired form of communication, for example, via dial-up modem connections, cable links, digital subscriber lines (DSL), wireless, or satellite links, or any other suitable form of communication.

The network 106 may be a wireless network, a wired network, or a combination thereof. The network 106 can also be an individual network or a collection of many such individual networks, interconnected with each other and functioning as a single large network, e.g., the Internet or an intranet. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, for providing a link between the trading position evaluation system 102 and the user devices 104. The network devices within the network 106 may interact with the trading position evaluation system 102, and the user devices 104 through the communication links.

The network environment 100 further comprises a database 108 communicatively coupled to the trading position evaluation system 102. The database 108 may store all data inclusive of data associated with a path-dependent ECC and its underlying asset sold by a trader, interchangeably referred to as an ECC seller in the present description. For example, the database 108 may store ECC data, historical data, and market data. As indicated previously, the ECC data includes, but is not limited to, a path-dependent ECC defined by its payoff, time of initiation, time to maturity, a plurality of discrete-monitoring time instances that lie between the time of initiation and time to maturity of the path-dependent ECC, premium, spot price of the underlying asset, strike price of the path-dependent ECC, and current market prices of plain vanilla call and put options written on the underlying asset of the path-dependent ECC with the same time to maturity. The historical data includes historical market prices of the underlying asset of the path-dependent ECC, and the market data includes annualized rate of return and annualized volatility of the underlying asset and risk-free interest rate of the market.

Although the database 108 is shown external to the trading position evaluation system 102, it will be appreciated by a person skilled in the art that the database 108 can also be implemented internal to the trading position evaluation system 102, wherein the ECC data, the historical data, and the market data may be stored within a memory component of the trading position evaluation system 102.

The trading position evaluation system 102 may further include processor(s) 110, interface(s) 112, and memory 114 coupled to the processor(s) 110. The processor(s) 110 may be implemented as one or more microprocessors, microcomputers, microcontrollers, digital signal processors, central processing units, state machines, logic circuitries, and/or any devices that manipulate signals based on operational instructions. Among other capabilities, the processor(s) 110 may fetch and execute computer-readable instructions stored in the memory 114.

Further, the interface(s) 112 may include a variety of software and hardware interfaces, for example, interfaces for peripheral device(s), such as a product board, a mouse, an external memory, and a printer. Additionally, the interface(s) 112 may enable the trading position evaluation system 102 to communicate with other devices, such as web servers and external repositories. The interface(s) 112 may also facilitate multiple communications within a wide variety of networks and protocol types, including wired networks, for example, LAN, cable, etc., and wireless networks, such as WLAN, cellular, or satellite. For the purpose, the interface(s) 112 may include one or more ports.

The memory 114 may include any computer-readable medium known in the art including, for example, volatile memory, such as static random access memory (SRAM), and dynamic random access memory (DRAM), and/or non-volatile memory, such as read only memory (ROM), erasable programmable ROM, flash memories, hard disks, optical disks, and magnetic tapes.

In one implementation, the trading position evaluation system 102 may include module(s) 116 and data 118. The module(s) 116 includes, for example, market parameter computation module 120, an interest rate calculation module 122, an option price determination module 124, a position evaluation module 126, and other module(s) 128. The other module(s) 128 may include programs or coded instructions that supplement applications or functions performed by the trading position evaluation system 102.

The data 118 may include ECC data 130, historical data 132, market data 134, parameter data 136, and other data 138. The ECC data 130 contains data associated with a path-dependent European Contingent Claim (ECC). In the description hereinafter, a path-dependent ECC is referred to as ECC. The ECC data 130 contains the ECC defined by its payoff, time of initiation, time to maturity of the ECC, a plurality of discrete-monitoring time instances that lie between the time of initiation and time to maturity of the ECC, its premium, spot price, strike price, and current market price of the plain vanilla call and put options written on an underlying asset of the ECC with the same time to maturity.

The historical data 132 includes historical market prices of the underlying asset of the ECC. The market data 134 includes annualized volatility, annualized rate of return, and risk-free interest rate. The parameter data 136 includes scaled option price and shifted scaled option price of the ECC. The other data 138, amongst other things, may serve as a repository for storing data that is processed, received, or generated as a result of the execution of one or more modules in the module(s) 116.

In the present embodiment, the ECC data 130, the historical data 132, and the market data 134 are depicted to be stored within the data 118, which is a repository internal to the trading position evaluation system 102. However, as described in the previous embodiment, the ECC data 130, the historical data 132, and the market data 134 may also be stored in the database 108 that is external to the trading position evaluation system 102.

According to the present subject matter, the market parameter computation module 120 retrieves historical data 132 for a predefined period, for example, past one year, from the data 118. As described previously, the historical data 132 includes historical market prices of the underlying asset of the ECC. Based on the retrieved historical data 132, the market parameter computation module 120 computes log-returns of the underlying asset. In one implementation, the market parameter computation module 120 computes the log-returns using the equation (1) provided below:

$${R}_{k} = log \frac{{S}_{k + 1}}{{S}_{k}} , k ∈ \{ 1 , … , m - 1 \} \qquad ( 1 )$$

wherein,
Rₖ represents a log-return of the underlying asset for kₜₕ period,
Sₖ represents the historical market price of the underlying asset for kₜₕ period, and
m represents a part of the historical data 132.

Subsequent to computing the log-returns, the market parameter computation module 120 may fit the log-returns for the underlying asset to a best-fit distribution. The best-fit distribution may be a Normal distribution, a Poisson distribution, a T-distribution, or any other known distribution that fits best to the log-returns, to generate a plurality of scenarios. The market parameter computation module 120 may then fit the generated scenarios to a normal distribution to compute rate of return (μ) and volatility (σ) of the underlying asset. The computed volatility and rate of return of the underlying asset is thereafter annualized. Further, the interest rate calculation module 122 of the trading position evaluation system 102 retrieves the ECC data 130 from the data 118 and computes the risk-free interest rate of the market based on the retrieved ECC data 130. According to one implementation, the interest rate calculation module 122 computes the risk-free interest rate using the equation (2) provided below:

$$r = \frac{1}{T} ln \frac{K}{{S}_{0} - C + P} \qquad ( 2 )$$

wherein,
r represents the risk-free interest rate,
C and P represent the current market prices of plain vanilla call and put option respectively, written on the underlying asset of the path-dependent ECC,
K represents the strike price of the plain vanilla call and put option,
T represents the time to maturity, and
S₀ represents the spot price of the underlying asset of the plain vanilla call and put option.

The annualized volatility (σ), the annualized rate of return (μ), and risk-free interest rate (r) are stored as the market data 134 and can be retrieved by the trading position evaluation system 102 while evaluating trading positions. Alternatively, the annualized volatility (σ), the annualized rate of return (μ), and risk-free interest rate (r) may be computed in real-time during evaluation of the trading positions. The manner in which the trading position evaluation system 102 evaluates the trading positions in the underlying asset of the ECC is described henceforth.

The trading position evaluation system 102 receives a plurality of trading time instances from a trader starting from the time of initialization till the time to maturity of the ECC. The trading time instances are the time instances at which the trader would like to trade. In the context of the present subject matter, the trading time instances are mathematically represented by the expression (3).

{T₀,T₁, . . . ,Tₙ} (3)

In the above equation, (T₀) represents the first trading time instance, which is also referred to as time of initiation, and (Tₙ), represents last trading time instance, which is also referred to as time of maturity.

At each of the trading time instances, the option price determination module 124 determines a scaled option price and a shifted scaled option price of the ECC based on the ECC data 130 and the market data 134. The scaled option price may be understood as the option price computed using a scaled price of the underlying asset of the ECC at any given trading time instance. The shifted scaled option price may be understood as the option price computed using a shifted scaled price of the underlying asset of the ECC at any given trading time instance.

The determination of the scaled option price and the shifted scaled option price is also based on at least one discrete-monitoring time instance occurring before a trading time instance at which the option price determination module 124 determines the scaled option price and the shifted scaled option price of the ECC. In the context of the present subject matter, the discrete-monitoring time instances are mathematically represented by the expression (4).

t={t₀,t₁, . . . ,t_{N}} (4)

In one implementation, the scaled option price and the shifted option price may be determined using a Black-Scholes pricing method or a Monte-Carlo pricing method. In an example, for a Cliquet option comprising one or more plain vanilla options, the scaled option price and the shifted scaled option price for the Cliquet option are determined by the option price determination module 124 using the equation (5), (6), (7) and (8) provided below. The scaled option price and the shifted scaled option price are evaluated at trading time Tᵢ₋₁.

V(Tᵢ₋₁,x)=e^{-r(T}^{ₙ}^{-T}^{ᵢ₋₁}⁾Σⱼ₌₁^{N}(e^{r((t}^{ⱼ} [symbol] ^{T}^{ᵢ₋₁}^{)-(t}^{ⱼ₋₁}^{VT}^{ᵢ₋₁}⁾⁾C_{BS}(xⱼ,xⱼ₋₁,tⱼ₋₁,VTᵢ₋₁,tⱼVTᵢ₋₁)),iε{1, . . . ,n}

wherein,
V(Tᵢ₋₁, x) represents scaled option price at current trading time Tᵢ₋₁ if x=e^{(μ-r)γ}^{ᵢ} [symbol] , or shifted scaled option price if x=^{e(μ-r+σ}^{²}^{)γ}^{ᵢ} [symbol] ,
tⱼ and tⱼ₋₁ represents discrete-monitoring time instances,
Tₙ−Tᵢ₋₁ is time to maturity from current trading time Tᵢ₋₁,
r represents the risk-free interest rate,
σ represents the annualized volatility of the underlying asset,
μ represents annualized rate of return of the underlying asset,
t represents the vector of discrete-monitoring time instances,
(t [symbol] Tᵢ₋₁)=(t₁ [symbol] Tᵢ₋₁, t₂ [symbol] Tᵢ₋₁, . . . , t_{N} [symbol] Tᵢ₋₁), where tᵢ [symbol] Tᵢ₋₁ represents min(tᵢ, Tᵢ₋₁),
tⱼ₋₁VTᵢ₋₁ represents max (tⱼ₋₁, Tᵢ₋₁),
tⱼVTᵢ₋₁ represents max (tⱼ, Tᵢ₋₁), and
γᵢ=(t [symbol] Tᵢ)−(t [symbol] Tᵢ₋₁) for every i=1, . . . , n and the product x∘y is the Hadamard or
element wise product of two vectors x and y.

In the said example, the term (C_{BS}) represents Black-Scholes price of a plain vanilla option, and is computed using the equation (6) provided below.

$$\begin{matrix}{C}_{BS} ( {S}_{o} , K , {T}_{i - 1} , {T}_{n} ) {=}^{Δ} {S}_{o} N ( {d}_{1} ) - {e}^{- r ( {T}_{n} - {T}_{i - 1} )} KN ( {d}_{2} ) & ( 6 ) \\ wherein , {d}_{1} = \frac{ln ( \frac{{S}_{O}}{K} ) + ( r + \frac{{σ}^{2}}{2} ) ( {T}_{n} - {T}_{i - 1} )}{σ \sqrt{( {T}_{n} - {T}_{i - 1} )}} , i ∈ \{ 1 , … , n \} & ( 7 ) \\ {d}_{2} = \frac{ln ( \frac{{S}_{O}}{K} ) + ( r - \frac{{σ}^{2}}{2} ) ( {T}_{n} - {T}_{i - 1} )}{σ \sqrt{( {T}_{n} - {T}_{i - 1} )}} , i ∈ \{ 1 , … , n \} & ( 8 )\end{matrix}$$

wherein,
Tₙ represents the last trading time instance or time to maturity,
S_{O} represents spot price of underlying asset of the plain vanilla option,
σ represents the annualized volatility of the underlying asset of the plain vanilla option, r represents the risk-free interest rate,
Tₙ−Tᵢ₋₁ is time to maturity from current trading time Tᵢ₋₁,
K represents the strike price of the plain vanilla option, and
N(d₁) and N(d₂) represents standard normal probability distribution function of intermediate terms d₁ and d₂.

The scaled option price and the shifted scaled option price computed by the option price determination module 124 for the ECC may be stored as the parameter data 136 within the trading position evaluation system 102.

Based on the scaled option price and the shifted scaled option price, the position evaluation module 126 of the trading position evaluation system 102 evaluates a trading position at each trading time instance in the underlying asset. According to an implementation of the present subject matter, the position evaluation module 126 retrieves the ECC data 130 and the market data 134 from the database 108 and evaluates trading positions in the underlying asset at a plurality of trading time instances. The determination of the scaled option price and the shifted scaled option price is based on at least one discrete-monitoring time instance occurring before that particular trading time instance. The trading positions, thus evaluated, are locally optimum in the market measure.

As indicated earlier, the trading positions conveys to the trader, the number of units of the underlying asset to be held until the next trading time instance in the underlying asset. Thus, for the underlying asset, the trading positions evaluated at each of the trading time instances starting from the time of initialization of the ECC till the time to maturity when taken together allow the seller to achieve minimum local variance of profit and loss at the time of maturity. The position evaluation module 126 computes the trading position, at a particular trading time instance, using the equation (9) provided below.

$${Δ}_{i}^{*} = \frac{{V}_{i - 1} ( {e}^{( μ - r + {σ}^{2} ) {γ}_{i}} ∘ {S}_{t ⋀ {T}_{i - 1}} ) - {V}_{i - 1} ( {e}^{( μ - r ) {γ}_{i}} ∘ {S}_{t ⋀ {T}_{i - 1}} )}{{e}^{( μ - r + {σ}^{2} ) {δ}_{i}} {S}_{i - 1} - ( {e}^{( μ - r ) {δ}_{i}} ) {S}_{i - 1}} , \\ i ∈ \{ 1 , … , n \} \qquad ( 9 )$$

wherein,
Δ*ᵢ represents trading position that are locally optimum in a market measure at (i−1)^{th} trading time instance,
Vᵢ₋₁(e^{(μ-r)γ}^{ᵢ} [symbol] ) represents scaled option price of the path-dependent ECC,
Sᵢ₋₁ represents the current market price of the underlying asset,
r represents the risk-free interest rate,
σ represents the annualized volatility of the underlying asset,
μ represents annualized rate of return of the underlying asset,
Vᵢ₋₁(e^{(μ-r+σ}^{²}^{)γ}^{ᵢ} [symbol] ) represents shifted scaled option price of the path-dependent ECC,
e^{(μ-r+σ}^{²}^{)δ}^{ᵢ} Sᵢ₋₁ represents the shifted scaled price of the underlying asset price at a trading time instance Tᵢ₋₁,
(e^{(μ-r)δ}^{ᵢ})Sᵢ₋₁ represents scaled price of the underlying asset at a trading time instance Tᵢ₋₁,
(t [symbol] Tᵢ₋₁)=(t₁ [symbol] Tᵢ₋₁, t₂ [symbol] tᵢ₋₁, . . . , t_{N} [symbol] Tᵢ₋₁), and
δᵢ is the time difference between the current trading instance and the next trading time instance.

The position evaluation module 126 evaluates the trading position at each trading time instance in the underlying asset. At the time of maturity, the trader liquidates the computed trading positions and delivers the payoff to the buyer. Taking an example of an ECC, a seller of the ECC gets premium (β) from the buyer and purchases Δ*₁ units of the underlying asset at price (S₀) at trading time instance (T₀). Thereafter, at trading time instance (T₁), the seller sells Δ*₁ units of the underlying asset at price (S₁) and repurchases Δ*₂ units of the underlying asset at price (S₁) and this continues till the time to maturity (Tₙ). The seller then, at the time of maturity (Tₙ) liquates the position, i.e., Δ*ₙ units of the underlying asset at price (Sₙ) and delivers the payoff (H) to the buyer of the ECC. Thus, according to the present subject matter, the trading positions that are locally optimum in the market measure are evaluated by using a simple analytical closed-form expression, i.e., the equation (9).

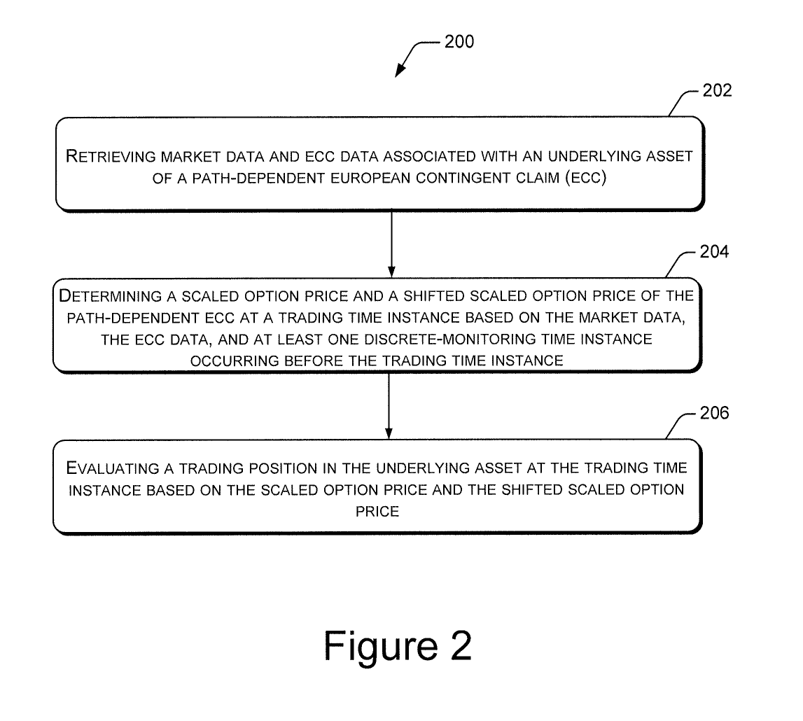

FIG. 2 illustrates a method 200 for evaluating trading positions for a path-dependent European Contingent Claim (ECC), according to an embodiment of the present subject matter. The method 200 is implemented in computing device, such as a trading position evaluation system 102. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network.

The order in which the method is described is not intended to be construed as a limitation, and any number of the described method blocks can be combined in any order to implement the method, or an alternative method. Furthermore, the method can be implemented in any suitable hardware, software, firmware or combination thereof.

At block 202, the method 200 includes retrieving ECC data and market data associated with an underlying asset of a path-dependent ECC. The ECC data may include the data associated with the path-dependent ECC, such as its payoff (H), time of initiation (T₀), time to maturity (Tₙ), a plurality of discrete-monitoring time instances that lie between the time of initiation (T₀) and time to maturity (Tₙ) of the path-dependent ECC, premium (β), spot price, strike price (K) and current market prices of call and put options written on the underlying asset of the path-dependent ECC at same time to maturity. The market data includes the annualized volatility (σ) of the underlying asset, annualized rate of return (μ) of the underlying asset, and the risk-free interest rate (r) of the market.

At block 204 of the method 200, a scaled option price and a shifted scaled option price of the path-dependent ECC are determined. The scaled option price and the shifted scaled option price of the path-dependent ECC are determined at a trading time instance based on the ECC data, the market data, and at least one discrete-monitoring time instance occurring before the trading time instance. The trading time instance is provided by a trader of the path-dependent ECC. In accordance with one implementation of the present subject matter, the option price determination module 124 determines the scaled option price and the shifted scaled option price of the path-dependent ECC.

At block 206 of the method 200, a trading position in the underlying asset at the trading time instance is evaluated based on the scaled option price and the shifted scaled option price. The evaluated trading position is locally optimum in a market measure. In one implementation, the position evaluation module 126 evaluates the locally optimum trading position in the underlying asset based on the equation (9) described in the previous section.

The method blocks 204 and 206 described above are repeated at each of a plurality of trading time instance provided by the trader to evaluate the trading positions at each trading time instance. At the last trading time instance, the trader such as the seller of the path-dependent ECC liquidates the underlying asset and delivers the payoff to the buyer in order to minimize the local variance of profit and loss at the time of maturity of the path-dependent ECC.

Although embodiments for methods and systems for evaluating trading positions that are locally optimum for path-dependent options have been described in a language specific to structural features and/or methods, it is to be understood that the invention is not necessarily limited to the specific features or methods described. Rather, the specific features and methods are disclosed as exemplary embodiments for evaluating the locally optimum trading positions for path-dependent options.

I/we claim:

1. A trading position evaluation system comprising:
a processor;
an option price determination module coupled to the processor to determine a scaled option price and a shifted scaled option price of a path-dependent European Contingent claim (ECC) based on ECC data and market data, retrieved from a database,
wherein the ECC data comprises data associated with the path-dependent ECC and an underlying asset of the path-dependent ECC, and the market data comprises annualized volatility of the underlying asset, annualized rate of return of the underlying asset and risk-free interest rate of market, and
wherein the scaled option price and the shifted scaled option price are determined at a trading time instance, selected from amongst a plurality of trading time instances obtained from a trader, based on at least one discrete-monitoring time instance occurring before the trading time instance; and
a position evaluation module coupled to the processor to evaluate a trading position in the underlying asset at the trading time instance based on the scaled option price and the shifted scaled option price, wherein the trading position minimizes local variance of profit and loss to the trader.

2. The trading position evaluation system as claimed in claim 1 further comprising a market parameter computation module coupled to the processor to:
retrieve historical data of the underlying asset from the database, wherein the historical data comprises historical market prices of the underlying asset;
compute log-returns of the underlying asset based on the historical data;
generate a plurality of scenarios based on fitting the log-returns into a best-fit distribution;
fit the plurality of scenarios to a normal distribution to compute volatility and rate of return of the underlying asset; and
annualize the volatility and the rate of return to obtain the annualized volatility and the annualized rate of return.

3. The trading position evaluation system as claimed in claim 1, wherein the ECC data comprises time of initiation of the path-dependent ECC, time to maturity of the path-dependent ECC, a plurality of discrete-monitoring time instances that lie between the time of initiation and time to maturity of the path-dependent ECC, premium, spot price of the underlying asset, strike price of the path-dependent ECC, and current market price of plain vanilla call and put options written on the underlying asset of the path-dependent ECC.

4. The trading position evaluation system as claimed in claim 1 further comprising an interest rate calculation module coupled to the processor to calculate the risk-free interest rate of the market based on the ECC data.

5. The trading position evaluation system as claimed in claim 2, wherein the best-fit distribution is one of a Normal distribution, a Poisson distribution, and a T-distribution.

6. A computer-implemented method for evaluating trading positions for a path-dependent European Contingent claim (ECC), wherein the method comprises:
receiving a plurality of trading time instances from a trader;
retrieving ECC data and market data associated with a path-dependent ECC from a database, wherein the ECC data comprises data associated with the path-dependent ECC and an underlying asset of the path-dependent ECC, and the market data comprises annualized volatility of the underlying asset, annualized rate of return of the underlying asset, and risk-free interest rate of market;
computing a scaled option price and a shifted scaled option price of the path-dependent ECC at a trading time instance, selected from amongst the plurality of trading time instances based on the ECC data, the market data, and at least one discrete-monitoring time instance occurring before the trading time instance; and
evaluating a trading position in the underlying asset at each of the plurality of trading time instances based on the scaled option price and the shifted scaled option price, wherein the trading position minimizes local variance of profit and loss to the trader.

7. The method as claimed in claim 6 further comprising:
retrieving historical data for a predefined period from the database;
evaluating log-returns of the underlying asset based on the historical data;
generating a plurality of scenarios based on fitting the log-returns into a best-fit distribution;
fitting the plurality of scenarios to a normal distribution to compute the volatility and the rate of return of the underlying asset; and
annualizing the volatility and the rate of return to obtain the annualized volatility and the annualized rate of return.

8. The method as claimed in claim 7, wherein the historical data comprises historical market prices of the underlying asset obtained from a data source.

9. The method as claimed in claim 6, wherein the ECC data comprises time of initiation of the path-dependent ECC, time to maturity of the path-dependent ECC, a plurality of discrete-monitoring time instances that lie between the time of initiation and time to maturity of the path-dependent ECC, premium, spot price of the underlying asset, strike price of the path-dependent ECC, and current market price of plain vanilla call and put options written on the underlying asset of the path-dependent ECC.

10. The method as claimed in claim 6 further comprising calculating the risk-free interest rate of the market based on the ECC data.

11. A non-transitory computer-readable medium having embodied thereon a computer program for executing a method comprising:
receiving a plurality of trading time instances from a trader;
retrieving ECC data and market data associated with a path-dependent ECC from a database, wherein the ECC data comprises data associated with the path-dependent ECC and an underlying asset of the path-dependent ECC, and the market data comprises annualized volatility of the underlying asset, annualized rate of return of the underlying asset, and risk-free interest rate of market;
computing a scaled option price and a shifted scaled option price of the path-dependent ECC at a trading time instance, selected from amongst the plurality of trading time instances based on the ECC data, the market data, and at least one discrete-monitoring time instance occurring before the trading time instance; and
evaluating a trading position in the underlying asset at each of the plurality of trading time instances based on the scaled option price and the shifted scaled option price, wherein the trading position minimizes local variance of profit and loss to the trader.

12. The non-transitory computer-readable medium as claimed in claim 11, wherein the method further comprising:
retrieving historical data for a predefined period from the database;
evaluating log-returns of the underlying asset based on the historical data;
generating a plurality of scenarios based on fitting the log-returns into a best-fit distribution;
fitting the plurality of scenarios to a normal distribution to compute the volatility and the rate of return of the underlying asset; and
annualizing the volatility and the rate of return to obtain the annualized volatility and the annualized rate of return.

13. The non-transitory computer-readable medium as claimed in claim 11, wherein the historical data comprises historical market prices of the underlying asset obtained from a data source.

14. The non-transitory computer-readable medium as claimed in claim 11, wherein the ECC data comprises time of initiation of the path-dependent ECC, time to maturity of the path-dependent ECC, a plurality of discrete-monitoring time instances that lie between the time of initiation and time to maturity of the path-dependent ECC, premium, spot price of the underlying asset, strike price of the path-dependent ECC, and current market price of plain vanilla call and put options written on the underlying asset of the path-dependent ECC.

15. The non-transitory computer-readable medium as claimed in claim 11 further comprising calculating the risk-free interest rate of the market based on the ECC data.
